(19) United States
(12) Patent Application Publication
(10) Pub. No.: US 2013/0107353 A1
(43) Pub. Date: May 2, 2013

(54) IFRARED FILTER WITH PROTECTION FILM AND LENS MODULE

(71) Applicant: YEN-CHUN CHEN, Tu-Cheng (TW)

(72) Inventor: YEN-CHUN CHEN, Tu-Cheng (TW)

(73) Assignee: HON HAI PRECISION INDUSTRY CO., LTD., Tu-Cheng (TW)

(21) Appl. No.: 13/330,708

(22) Filed: Dec. 20, 2011

(30) Foreign Application Priority Data
Oct. 26, 2011 (TW) 100138991

(51) Int. Cl. G02B 13/14

(52) U.S. Cl. 359/356

(57) ABSTRACT

A lens module includes a barrel, at least one lens, and an infrared filter. The at least one lens is received in the barrel. The infrared filter is received in the barrel and neighboring the at least one lens. The infrared filter includes a circular glass substrate and an annular protection film. The circular glass includes two opposite surface. An outer diameter of the protection film is substantially equal to the diameter of the glass substrate. The protection film is coaxially adhered to one of the surfaces.

### BACKGROUND

1. Technical Field

The present disclosure relates to infrared filters and, particularly, to an infrared filter with a protection film and a lens module using the infrared filter.

2. Description of Related Art

Lens modules usually include a barrel, an infrared filter received in the barrel, and at least one lens received in the barrel neighboring the infrared filter. The infrared filter is made of a colored or transparent glass substrate by grinding the glass substrate into a circular shape. Residual stresses are distributed at the periphery of infrared filter after grinding, which makes the periphery of the infrared filter fragile. When assembling the infrared filter, the periphery of the infrared filter usually collides with the inner surface of the barrel and may crack, generating glass particles. The glass particles fall onto the lens and influence the image quality of the lens modules.

Therefore, it is desirable to provide an infrared filter, which can overcome the limitations described.

### BRIEF DESCRIPTION OF THE DRAWINGS

FIG. 1 is a cross-sectional schematic view of a lens module, according to a first embodiment of the present disclosure.

FIG. 2 is an isometric schematic view of an infrared filter of the lens module of FIG. 1.

FIG. 3 is s a cross-sectional schematic view of a lens module, according to a second embodiment of the present disclosure.

### DETAILED DESCRIPTION

Embodiments of the disclosure will be described in detail, with reference to the accompanying drawings.

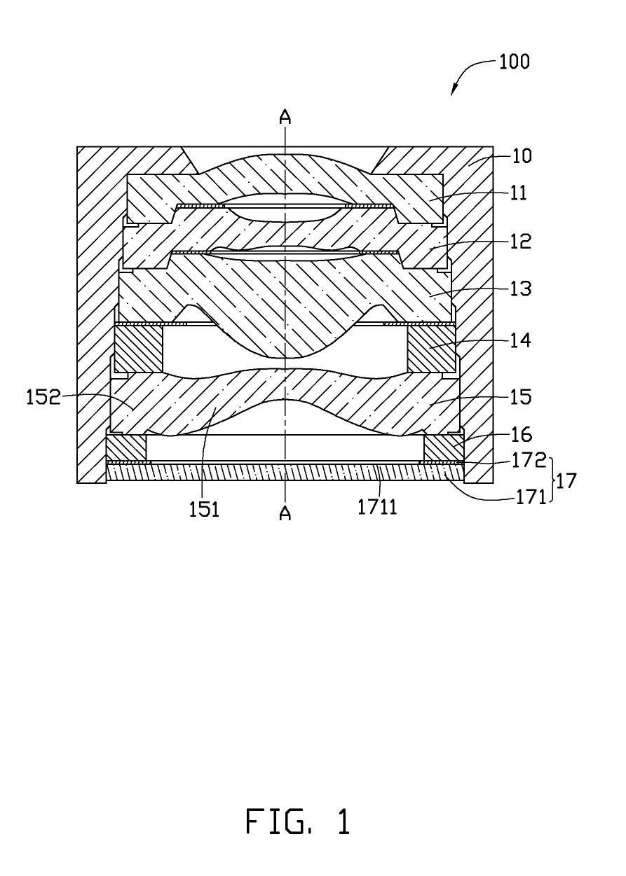

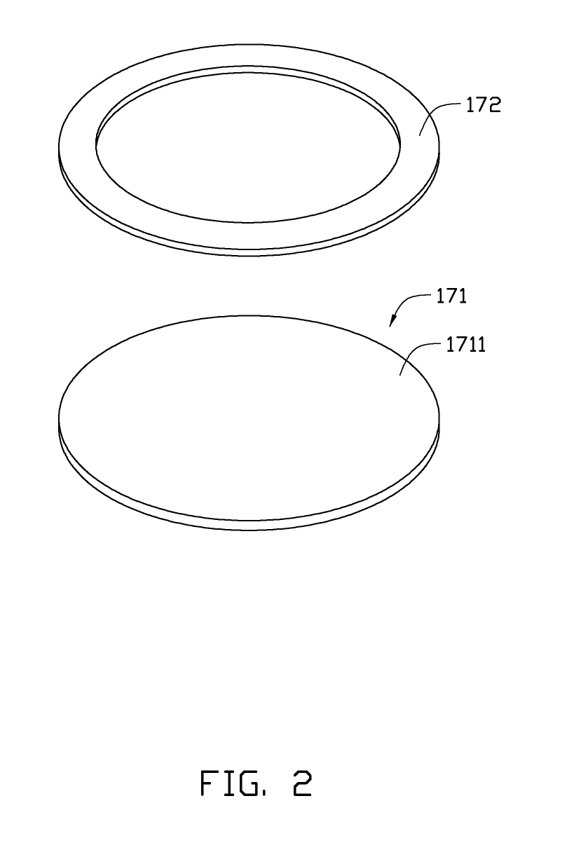

Referring to FIG. 1 and FIG. 2, a lens module 100, according to a first embodiment, is shown. The lens module 100 includes a barrel 10 and a first lens 11, a second lens 12, a third lens 13, a spacer 14, a fourth lens 15, a fixing member 16, and an infrared filter 17. All of the first lens 11, the second lens 12, the third lens 13, the spacer 14, the fourth lens 15, the fixing member 16 and the infrared filter 17 are arranged in the barrel 10 in an order from an object side to an image side of the lens module 100.

The first lens 11 is held by the second lens 12. The second lens 12 is held by the third lens 13. The spacer 14 is annular and arranged between the third lens 13 and the fourth lens 14. The spacer 14 can be made of rubber or plastic. In this embodiment, the spacer 14 is made of rubber.

The fourth lens 15 includes an imaging portion 151 and a non-imaging portion 152 surrounding the imaging portion 151. The imaging portion 151 generates images by directing passing light rays in a predetermined fashion. The non-imaging portion 152 supports the imaging portion 151 and is fixed to the inner surface of the barrel 10.

The fixing member 16 is made of plastic or rubber and generally annular. In this embodiment, the fixing member 16 is made of opaque material such as black plastic. The fixing member 16 is mounted between the non-imaging portion 152 and the infrared filter 17. The fixing member 16 fixes the fourth lens 15. The orthogonal projection of the non-imaging portion 152 on a projection plane perpendicular to an optical axis AA of the lens module 100 is within that of the fixing member 16. The thickness of the fixing member 16 is about 0.25 millimeters.

The infrared filter 17 is neighboring the fourth lens 15 and includes a circular glass substrate 171 and a protection film 172. The glass substrate 171 is made of a glass substrate (not shown) such as a square glass substrate by grinding the square glass substrate to a circular shape. The glass substrate 171 includes two opposite surfaces 1711. The glass substrate 171 can be transparent and coated with infrared filtering material on at least one of the surfaces 1711 such that the glass substrate 171 can filter out infrared light rays. In this embodiment, the glass substrate 171 is a colored glass having infrared filtering characteristics, namely, the glass substrate 171 can filter out infrared light rays.

The protection film 172 is made of transparent plastic and generally annular. The thickness of the protection film 172 is about 0.035 millimeters. An outer diameter of the protection film 172 is substantially equal to a diameter of the glass substrate 171. The protection film 172 is adhered to one of the surfaces 1711 of the glass substrate 171. In this embodiment, the protection film 172 is adhered to the surface 1711 adjacent to the fixing member 16 relative to the other surface 1711. The protection film 172 is coaxial with the glass substrate 171 and the periphery of the protection 172 is aligned with the periphery of the glass substrate 171.

The glass substrate 171 is made of the square glass substrate by grinding the square glass substrate to a circular shape. Residual stresses are distributed at the periphery of the glass substrate 171, which makes the periphery of the glass substrate 171 fragile. The protection film 172 adhered to the periphery of the surface 1711 adjacent to the fixing member 16 relative to the other surface 1711 enhances the strength of the periphery of the glass substrate 171. When assembling the infrared filter 17 into the barrel 10, the protection film 172 can prevent the periphery of the glass substrate 171 from cracking and generating glass particles when colliding with inner surface of the barrel 10.

In alterative embodiments, the lens module 100 can includes two protection films 172. Each of the protection films 172 is coaxially adhered to one of the surfaces 1711 of the glass substrate 171. Therefore, the strength of the periphery of the glass substrate 171 can be further enhanced.

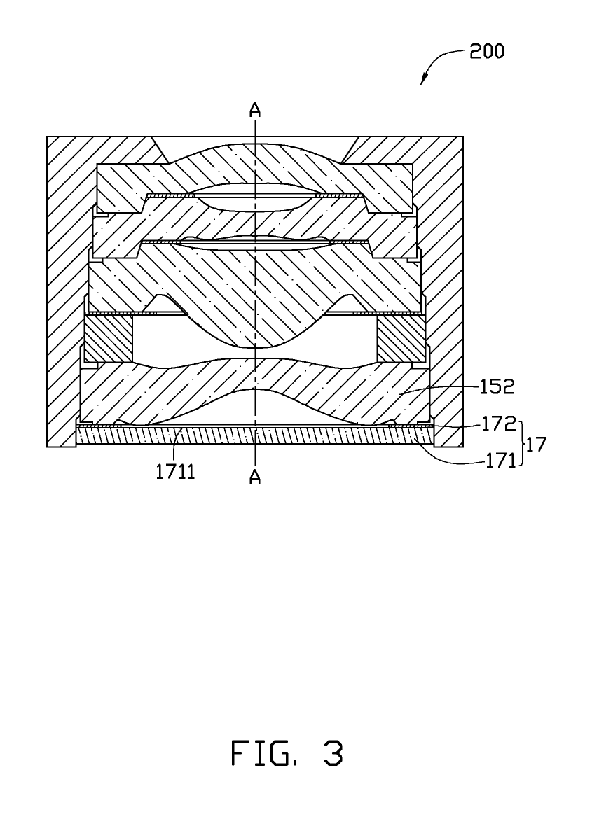

Referring to FIG. 3, a lens module 200, according to a second embodiment, is shown. The lens module 200 of the second embodiment is similar to the lens module 100 of the first embodiment, except that the fixing member 16 of the lens module 100 of the first embodiment is omitted and the protection film 172 is made of opaque material. For instance, the protection film 172 can be made of polyethylene terephthalate (PET) polyester. The thickness of the protection film 172 is about 0.035 millimeters. An outer diameter of the protection film 172 is substantially equal to a diameter of the glass substrate 171. The protection film 172 is adhered to one of the surfaces 1711 of the glass substrate 171. In this embodiment, the protection film 172 is adhered to the surface 1711 adjacent to the non-imaging portion 152 relative to the other surface 1711. The protection film 172 is coaxial with glass substrate 171 and the periphery of the protection 172 is aligned with the periphery of the glass substrate 171. The orthogonal projection of the non-imaging portion 152 on a projection plane perpendicular to the optical axis AA of the lens module 200 is within that of the protection film 172. When assembling the infrared filter 17 into the barrel 10, the protection film 172 can prevent the periphery of the glass substrate 171 from cracking and generating glass particles when colliding with inner surface of the barrel 10. The volume of the lens module 200 can be further minimized related to the lens module 100 of the first embodiment because of the omission of the fixing member 16. In this embodiment, the lens module 200 also can include two protection films 172. Each of the protection films 172 is coaxially adhered to one of the surfaces 1711 of the glass substrate 171.

Particular embodiments are shown here and described by way of illustration only. The principles and the features of the present disclosure may be employed in various and numerous embodiments thereof without departing from the scope of the disclosure as claimed. The above-described embodiments illustrate the scope of the disclosure but do not restrict the scope of the disclosure.

What is claimed is:

1. A lens module, comprising:
a barrel;
at least one lens received in the barrel; and
an infrared filter received in the barrel and neighboring the at least one lens;
wherein the infrared filter comprises a circular glass substrate and an annular protection film; the glass substrate comprises two opposite surfaces; an outer diameter of the protection film is substantially equal to a diameter of the glass substrate; the protection film is coaxially adhered to one of the surfaces.

2. The lens module of claim 1, wherein the lens module comprises another protection film; an outer diameter of the another protection film is substantially equal to the diameter of the glass substrate; the another protection films is coaxially adhered to the other of the surfaces.

3. The lens module of claim 1, wherein the at least one lens comprises a lens, the lens comprises an imaging portion for generating images and a non-imaging portion surrounding imaging portion; the lens module further comprises a fixing member mounted between the non-image portion and the infrared filter; the fixing member fixes the lens on the barrel; the fixing member is made of black plastic; the orthogonal projection of the non-imaging portion on a projection plane perpendicular to an optical axis of the lens module is within that of the fixing member.

4. The lens module of claim 3, wherein the protection film is made of transparent plastic.

5. The lens module of claim 1, wherein the at least one lens comprises a lens, the lens comprises an imaging portion for generating images and a non-imaging portion surrounding imaging portion; the protection film faces the lens and is made of opaque material; the orthogonal projection of the non-imaging portion on a projection plane perpendicular to the optical axis of the lens module is within that of the protection film.

6. The lens module of claim 5, wherein the protection film is made of polyethylene terephthalate polyester.

7. The lens module of claim 1, wherein the glass substrate is made of a colored glass substrate having infrared filtering characteristics.

8. An infrared filter for being received in a barrel of a lens module, comprising:
a circular glass substrate comprising two opposite surface; and
an annular protection film; an outer diameter of the protection film is substantially equal to a diameter of the glass substrate; the protection film being coaxially adhered to one of the surfaces.

9. The infrared filter of claim 8, wherein the infrared filter comprises another protection film; an outer diameter of the another protection films is substantially equal to the diameter of the glass substrate; the another protection films is coaxially adhered to the other one of the surfaces.

10. The lens module of claim 8, wherein the protection film is made of transparent plastic.

11. The lens module of claim 8, wherein the protection film is made of opaque material.

12. The lens module of claim 11, wherein the protection film is made of polyethylene terephthalate polyester.

13. The lens module of claim 1, wherein the glass substrate is made of a colored glass substrate having infrared filtering characteristics.
